(19) United States
(12) Patent Application Publication
(10) Pub. No.: US 2012/0210078 A1
(43) Pub. Date: Aug. 16, 2012

(54) ARBITER, STORAGE DEVICE, INFORMATION PROCESSING DEVICE AND COMPUTER PROGRAM PRODUCT

(75) Inventors: Tomoya HORIGUCHI, Tokyo (JP); Seijiro YONEYAMA, Kanagawa (JP)

(73) Assignee: KABUSHIKI KAISHA TOSHIBA, Tokyo (JP)

(21) Appl. No.: 13/369,541

(22) Filed: Feb. 9, 2012

(30) Foreign Application Priority Data
Feb. 14, 2011 (JP) 2011-029062

(51) Int. Cl. G06F 12/00

(52) U.S. Cl. 711/154; 711/E12.001

(57) ABSTRACT

According to an embodiment, an arbiter is for arbitrating accesses to a first memory and a second memory from a first device having a cache memory for temporarily storing data and a second device. The arbiter includes a first writing unit configured to write data requested to be written by the second device into the second memory; and a notifying unit configured to notify the first device of completion of writing the data into the second memory.

### CROSS-REFERENCE TO RELATED APPLICATION(S)

This application is based upon and claims the benefit of priority from Japanese Patent Application No. 2011-029062, filed on Feb. 14, 2011; the entire contents of which are incorporated herein by reference.

### FIELD

Embodiments described herein relate generally to an arbiter, a storage device, an information processing device and a computer program product.

### BACKGROUND

Memory cards called Eye-Fi (registered trademark) are known. An Eye-Fi (registered trademark) card includes an interface (host interface) to a host (such as a personal computer and a digital camera), a communication interface with a wireless LAN (local area network) and a memory. Under present circumstances, reading and writing from/to a memory by a host and reading from a memory by a communication interface can be performed, but writing to a memory by a communication interface is not performed, which is limited as a use case.

A case where writing by a communication interface is permitted and writing by a host interface occurs after writing by the communication interface is made is assumed here. A cache area is typically present in the host. The host reads out information of a file allocation table (hereinafter referred to as FAT) from the cache and determines a write data address based on the read information. In this case, when writing from the communication interface is made, a state of the cache area and a state of an actual memory becomes different from each other, that is, becomes a state so-called cache inconsistency. If data write from the host is performed in this state, a file may be destroyed and, in addition, the FAT area may be destroyed.

### BRIEF DESCRIPTION OF THE DRAWINGS

FIG. 1 is a block diagram of an information processing device according to a first embodiment;

FIG. 2 is a block diagram of an arbitrating unit according to the first embodiment;

FIG. 3 is a sequence diagram of an arbitration process according to the first embodiment;

FIG. 4 is a block diagram of an arbitrating unit according to a second embodiment;

FIG. 5 is a sequence diagram of an arbitration process according to the second embodiment; and

FIG. 6 is a block diagram of a storage device according to a third embodiment.

### DETAILED DESCRIPTION

According to an embodiment, an arbiter is for arbitrating accesses to a first memory and a second memory from a first device having a cache memory for temporarily storing data and a second device. The arbiter includes a first writing unit configured to write data requested to be written by the second device into the second memory; and a notifying unit configured to notify the first device of completion of writing the data into the second memory.

Various embodiments will be described hereinafter with reference to the accompanying drawings.

### First Embodiment

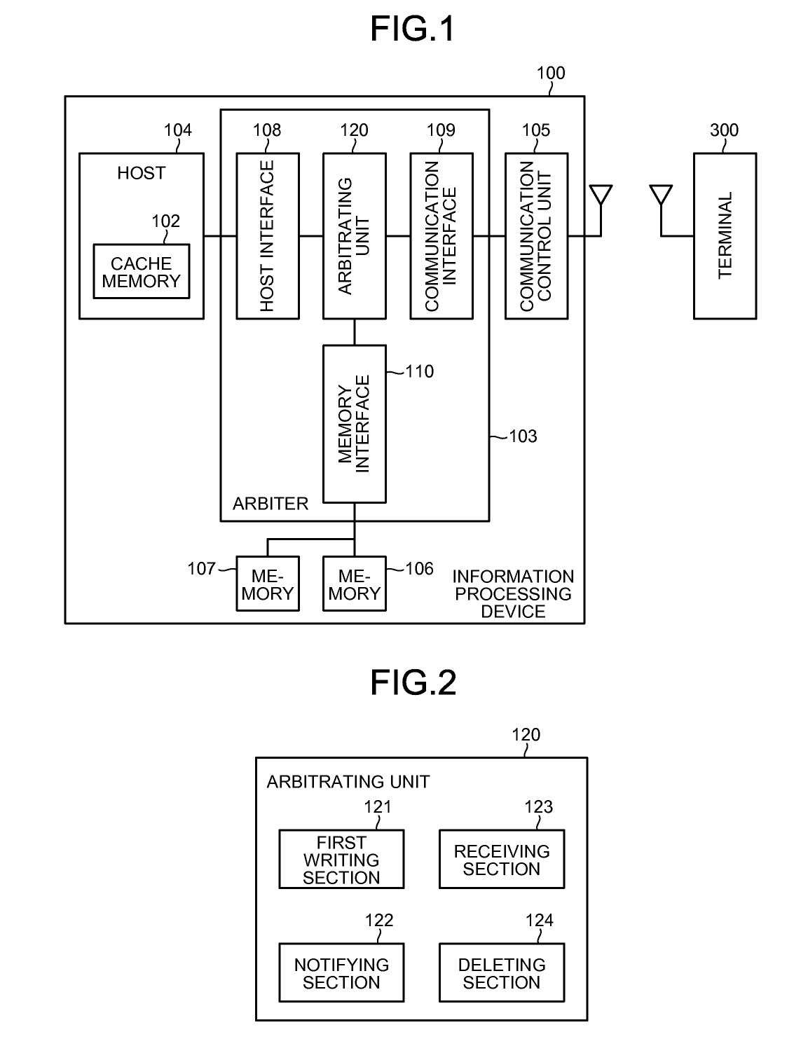

FIG. 1 is a block diagram illustrating an example of a configuration of an information processing device 100 according to a first embodiment. As illustrated in FIG. 1, the information processing device 100 includes a host 104, a communication control unit 105, a memory 106, a memory 107 and an arbiter 103. The information processing device 100 can communicate with a terminal 300 via the communication control unit 105.

The host 104 is a device that accesses storage units (a memory 106 and a memory 107), accesses to which are arbitrated by the arbiter 103. In this embodiment, the host 104 is a main processor, for example, and controls the entire information processing device 100. The host 104 includes a cache memory 102 that temporarily stores data. Note that the host 104 is not limited to a main processor but any device may be applied as long as the device has a cache function of temporarily storing data to be stored in a storage unit.

The communication control unit 105 controls communication with the terminal 300 according to a predetermined communication protocol. The communication protocol may be wireless communication through a cellular radio network, a wireless LAN, WiMAX, Bluetooth (registered trademark) or infrared communication, or may be wired communication through a USB (universal serial bus) or a LAN, for example.

The memory 106 and the memory 107 are storage units that store data. The memory 106 and the memory 107 may be volatile memories such as SRAM (static random access memory) and DRAM (dynamic random access memory) or may be nonvolatile memories such as a NAND Flash, a NOR Flash, a HDD (hard disk drive) and an optical disc.

Although the memory 106 and the memory 107 are illustrated as separate blocks in FIG. 1, physically one or a plurality of memory units may be divided into logical block addresses and used as the memory 106 and the memory 107. Alternatively, physically one or a plurality of memory units may be divided by a partition for a file system and used as the memory 106 and the memory 107. Still alternatively, different types of memory units having different characteristics from each other may be used as the memory 106 and the memory 107, respectively.

The arbiter 103 includes a host interface 108, a communication interface 109, a memory interface 110 and an arbitrating unit 120.

The host interface 108 is an interface receiving memory accesses from the host 104. The host interface 108 may be a USB, a PCI (peripheral component interconnect), a PCI Express, an SD memory, SDIO, IEEE 1394 and a general-purpose memory IF (interface), for example.

The communication interface 109 is an interface according to the communication protocol used by the communication control unit 105. If the communication protocol is the USB, an UTMI (USB transceiver macrocell interface) can be applied as the communication interface 109. If the communication protocol is LAN-based, a general interface such as MII (media independent interface)/GMII (gigabit media independent interface) can be applied as the communication interface 109. The communication interface 109 may be a unique interface specific to the communication control unit 105.

The memory interface 110 is an interface to the memory 106 and the memory 107. The memory interface 110 may be a memory interface to a general purpose SRAM/DRAM/DDR SDRAM (double-data-rate synchronous dynamic random access memory) or the like, for example. Alternatively, the memory interface 110 may be a NAND memory interface such as eMMC and eSD, for example.

The arbitrating unit 120 arbitrates accesses to the memory 106 and the memory 107 from the host 104 and accesses to the memory 106 and the memory 107 from the terminal 300. For example, the arbitrating unit 120 performs exclusive control of accesses to the memory 106 and the memory 107. The arbitrating unit 120 also performs control for preventing inconsistencies in a file system or the like (which will be described later in detail).

FIG. 2 is a block diagram illustrating an example of a functional configuration of the arbitrating unit 120 according to the first embodiment. As illustrated in FIG. 2, the arbitrating unit 120 includes a first writing section 121, a notifying section 122, a receiving section 123 and a deleting section 124.

The first writing section 121 writes data requested to be written by the terminal 300 into the memory 107. The notifying section 122 notifies the host 104 of completion of data write into the memory 107. The receiving section 123 receives, from the host 104, completion of data write from the memory 107 into the memory 106. When the completion of data write from the memory 107 into the memory 106 is received, the deleting section 124 deletes the data from the memory 107.

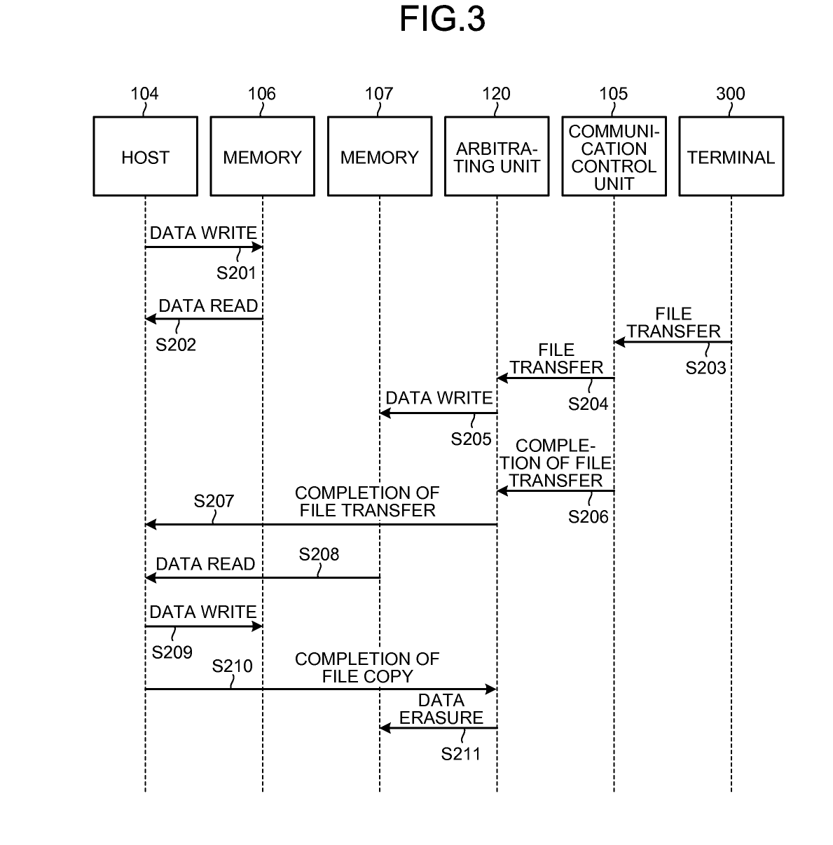

Next, an arbitration process performed by the information processing device 100 having such a configuration according to the first embodiment will be described referring to FIG. 3. FIG. 3 is a sequence diagram illustrating the entire flow of the arbitration process according to the first embodiment.

In normal memory accesses, the host 104 performs data write into the memory 106 (step S201) and data read from the memory 106 (step S202). The host 104 has a cache area (cache memory 102). The host 104 reads out FAT information or the like in advance from the memory 106, stores the information in the cache memory 102 and uses the information for accesses to the memory 106.

It is assumed here that a data write access is made from the terminal 300. For example, the terminal 300 transfers a file of data to be written to the information processing device 100 (step S203). The communication control unit 105 notifies the arbitrating unit 120 that a file is transferred (step S204). The first writing section 121 of the arbitrating unit 120 writes the transferred file into the memory 107 (step S205).

In this manner, the arbitrating unit 120 writes data requested to be written by the terminal 300 only into the memory 107 but not into the memory 106. Accordingly, files and FAT information are not broken even if the memory 106 is accessed by the host 104 by using FAT information cached previously.

When the file transfer from the terminal 300 is completed, the communication control unit 105 notifies the arbitrating unit 120 of the completion of file transfer (step S206). In response to the notification, the notifying section 122 of the arbitrating unit 120 notifies the host 104 of the completion of file transfer (step S207). At this time, information (folder name, file name, etc.) on the file transferred from the terminal 300 is also notified. The host 104 reads the file from the memory 107 based on the notified information during idle time between memory accesses (step S208), and copies the read file into the memory 106 (step S209).

As a result of copying the file by the host 104, the state of the cache memory 102 can be updated with the latest FAT information of the memory 106. Therefore, destruction of a file due to inconsistency in the FAT information does not occur even if a file accessing process from the host 104 to the memory 106 is performed again.

The host 104 notifies the arbitrating unit 120 that copying of the file is finished (step S210). The receiving section 123 of the arbitrating unit 120 receives this notification. When the notification is received, the deleting section 124 of the arbitrating unit 120 erases the file transferred from the terminal 300 from the memory 107 (step S211). Accordingly, it is possible to reserve an area for saving the next file when such file is transferred from the terminal 300.

It may be configured such that a write access from the host 104 to the memory 106 is inhibited until the arbitrating unit 120 receives a notification of copy completion from the host 104.

Note that the transfer rates required for the data transfer from the terminal 300 and for the copying of data from the memory 107 into the memory 106 may be different from each other depending on the types of applications used therefor. In such case, the characteristics of the memory 106 and the memory 107 may be selected based on the applications. For example, when a file is transferred at high speed from the terminal 300 and used at the host 104 offline later, it is preferable that a memory into which data can be written at high speed be mounted as the memory 107 and a large-capacity memory with low speed be mounted as the memory 106.

As described above, in the first embodiment, a plurality of memory areas (the memory 106 and the memory 107) are provided, data from the terminal 300 at the other end of communication are written in one of the memory areas (the memory 107), and completion of writing is notified to the host 104. Accordingly, the host 104 can copy the data into another memory area (the memory 106) at a desired timing. It is therefore possible to avoid occurrence of cache inconsistency even when writing from the communication interface is enabled.

### Second Embodiment

In the first embodiment, the host 104 copies data from the memory 107 into the memory 106. In the second embodiment, the arbiter copies data from the memory 107 into the memory 106.

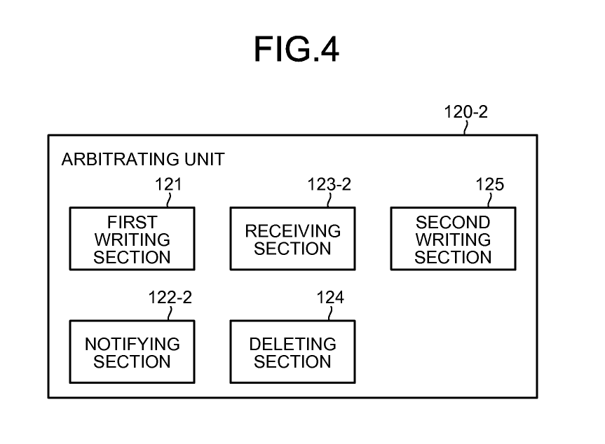

FIG. 4 is a block diagram illustrating an example of a functional configuration of an arbitrating unit 120-2 according to the second embodiment. As illustrated in FIG. 4, the arbitrating unit 120-2 includes the first writing section 121, a notifying section 122-2, a receiving section 123-2, the deleting section 124 and a second writing section 125.

The second embodiment is different from the first embodiment in the functions of the notifying section 122-2 and the receiving section 123-2 and in that the second writing section 125 is additionally provided. The other components and functions are the same as those in FIG. 2 that is a block diagram of the arbitration unit 120 according to the first embodiment. Therefore, these are indicated by the same reference numerals and description thereof will not repeated here.

A host 104-2 of the second embodiment is different from the host 104 of the first embodiment in that the host 104-2 sends a request for writing data (file) written in the memory 107 into the memory 106 to the arbiter after receiving a notification of file transfer completion.

The receiving section 123-2 receives, from the host 104-2, a request for writing data written in the memory 107 by the first writing section 121 into the memory 106.

The second writing section 125 reads data for which a write request into the memory 106 is received from the memory 107 and writes the read data into the memory 106.

The notifying section 122-2 is different from the notifying section 122 of the first embodiment in that the notifying section 122-2 further has a function of notifying the host 104-2 of completion of data write by the second writing section 125.

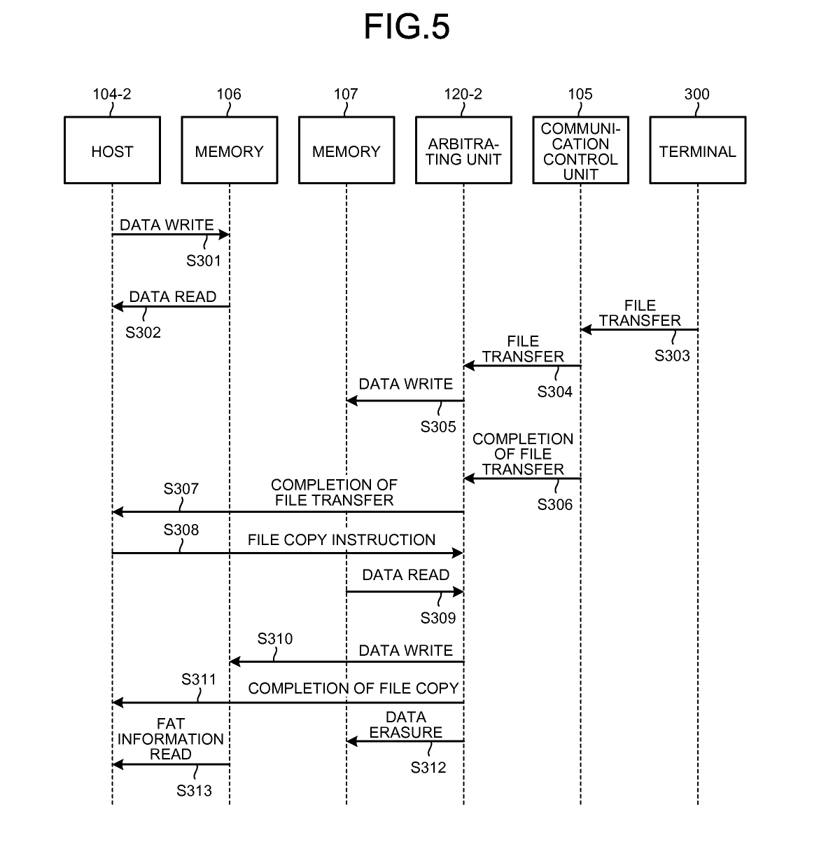

Next, an arbitration process performed by the information processing device having such a configuration according to the second embodiment will be described referring to FIG. 5. FIG. 5 is a sequence diagram illustrating the entire flow of the arbitration process according to the second embodiment.

Since processing from step S301 to step S307 is similar to that from step S201 to step S207 of the arbitration process of the first embodiment (FIG. 3), the description thereof will not be repeated.

When completion of file transfer is notified in step S307, the host 104-2 notifies the arbitrating unit 120 of a file copy instruction during idle time between memory accesses (step S308). The receiving section 123-2 of the arbitrating unit 120-2 receives the file copy instruction. When the file copy instruction is received, the second writing section 125 of the arbitrating unit 120-2 determines that it is authorized to access the memory 106, reads data of the file sent from the terminal 300 from the memory 107 (step S309), and writes the read data into the memory 106 (step S310). When copying of the file is completed, the notifying section 122-2 of the arbitrating unit 120-2 notifies the host 104-2 of completion of file copy (step S311). The deleting section 124 of the arbitrating unit 120-2 erases the file transferred from the terminal 300 from the memory 107 (step S312). Accordingly, it is possible to reserve an area for saving the next file when such file is transferred from the terminal 300.

The host 104-2 inhibits itself from performing write access to the memory 106 until completion of copying is notified after a file copy instruction is issued. Alternatively, it may be configured such that the arbitrating unit 120-2 inhibits write access to the memory 106 from the host 104-2.

When completion of file copying is notified, the host 104-2 reads the FAT information updated as a result of copying the file (step S313). Accordingly, it is possible to resolve inconsistency (inconsistency state) between the FAT information remaining in the cache (the cache memory 102) of the host 104-2 and the FAT information in the memory 106. In other words, the state of the cache of the host 104-2 can be updated with the latest FAT information of the memory 106 as a result of the process described above. Therefore, destruction of a file due to inconsistency in the FAT information does not occur even if a file accessing process from the host 104-2 to the memory 106 is performed again.

### Third Embodiment

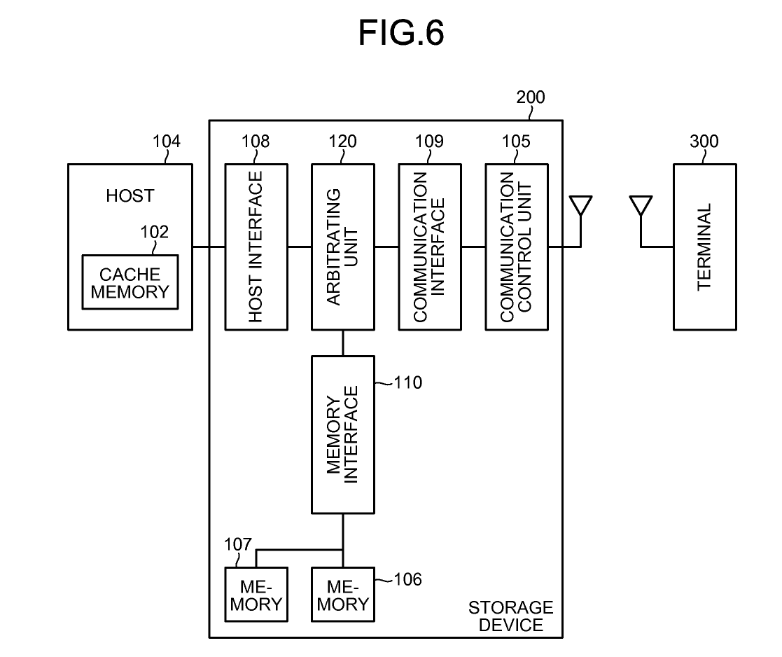

In the description above, examples in which the arbiter is provided in the information processing device have been presented. Applicable configurations are not limited to these examples. For example, the components included in the arbiter described above and memories may be included in a storage device. FIG. 6 is a block diagram illustrating an example of a storage device 200 having such a configuration according to the third embodiment.

As illustrated in FIG. 6, the storage device 200 includes the host interface 108, the communication interface 109, the memory interface 110, the arbitrating unit 120, the memory 106, the memory 107 and the communication control unit 105. Since the components included in the storage device 200 have functions similar to those in FIG. 1, the description thereof will not be repeated.

In such a configuration, the host 104 may be a PC, a mobile terminal, or a mobile phone having a main processor and the cache memory 102, for example. The storage device 200 may be a USB memory having a radio communication function (the communication control unit 105), for example.

As described above, according to the first to third embodiments, occurrence of a cache inconsistency state, destruction of a file, and the like can be avoided.

The functions of the arbitrating unit may be implemented by a hardware circuit, or may be implemented in software by executing a program including the functions of the arbitrating unit by a CPU (processor) in the arbiter, for example.

Programs to be executed by the devices according to the first to third embodiments are recorded on a computer readable recording medium such as a compact disk read only memory (CD-ROM), a flexible disk (FD), a compact disk recordable (CD-R) and a digital versatile disk (DVD) in a form of a file that can be installed or executed, and provided as a computer program product.

Alternatively, the programs to be executed by the devices according to the first to third embodiments may be stored on a computer system connected to a network such as the Internet, and provided by being downloaded via the network. Alternatively, the programs to be executed by the devices according to the first to third embodiments may be provided or distributed through a network such as the Internet.

Still alternatively, the programs in the first to third embodiments may be embedded on a ROM or the like in advance and provided therefrom.

The programs to be executed by the devices according to the first to third embodiments have modular structures including the respective sections (first writing section, notifying section, receiving section, deleting section) described above. In an actual hardware configuration, the CPU (processor) reads the programs from the recording medium mentioned above and executes the programs, whereby the respective sections are loaded on a main storage device and generated thereon.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An arbiter for arbitrating accesses to a first memory and a second memory from a first device having a cache memory for temporarily storing data and a second device, the arbiter comprising:
a first writing unit configured to write data requested to be written by the second device into the second memory; and
a notifying unit configured to notify completion of writing the data into the second memory to the first device.

2. The arbiter according to claim 1, further comprising:
a receiving unit configured to receive, from the first device, a request for writing the data written in the second memory by the first writing unit into the first memory; and
a second writing unit configured to read a read data for which the request is received from the second memory and write the read data into the first memory.

3. The arbiter according to claim 2, wherein
the notifying unit is further configured to notify completion of writing the read data into the first memory by the second writing unit to the first device, and
the arbiter further includes a deleting unit configured to delete, from the second memory, the data completed to be written into the first memory by the second writing unit.

4. The arbiter according to claim 1, further comprising:
a receiving unit configured to receive, from the first device, completion of writing the data written in the second memory by the first writing unit into the first memory; and
a deleting unit configured to delete, from the second memory, the data for which the completion of writing is received.

5. A storage device connected to a first device including a cache memory for temporarily storing data and a second device, the storage device comprising:
a first memory;
a second memory;
a first writing unit configured to write data requested to be written by the second device into the second memory; and
a notifying unit configured to notify completion of writing the data into the second memory to the first device.

6. The storage device according to claim 5, wherein
the first memory and the second memory are memories obtained by dividing one or more physical memories into logical block addresses.

7. The storage device according to claim 5, wherein
the first memory and the second memory are obtained by dividing one or more physical memories by a partition for a file system.

8. An information processing device connected to an external device, the information processing device comprising:
a first memory;
a second memory;
a first device including a cache memory for temporarily storing data;
a first writing unit configured to write data requested to be written by the external device into the second memory; and
a notifying unit configured to notify completion of writing the data into the second memory to the first device.

9. A computer program product comprising a computer-readable medium having programmed instructions, wherein the instructions, when executed by a computer used as an arbiter configured to arbitrate accesses to a first memory and a second memory from a first device having a cache memory for temporarily storing data and a second device, cause the computer to execute:
writing data requested to be written by the second device into the second memory; and
notifying completion of writing the data into the second memory to the first device.
